(19) United States
(12) Patent Application Publication
(10) Pub. No.: US 2013/0170936 A1
(43) Pub. Date: Jul. 4, 2013

(54) Self-Aligning Pick and Place Collet for Tape and Reel Machine

(71) Applicants: Hong Sia Tan, Singapore (SG); Chee Mang Wong, Singpore (SG); Yik Loong Leong, Singpore (SG)

(72) Inventors: Hong Sia Tan, Singapore (SG); Chee Mang Wong, Singpore (SG); Yik Loong Leong, Singpore (SG)

(73) Assignee: Avago Technologies ECBU IP (Singapore) Pte. Ltd., Fort Collins, CO (US)

(21) Appl. No.: 13/342,241

(22) Filed: Jan. 3, 2012

(51) Int. Cl. B25J 15/06; B25J 9/00; B25J 11/00

(52) U.S. Cl. 414/752.1; 294/183

(57) ABSTRACT

Various embodiments of methods and devices are provided for a self-aligning pick and place collet having proximal and distal ends configured for use with a tape and reel machine. A suction area is located at a distal end of the collet. A pick and place collet contact area is located adjacent to and outwardly from the suction area, and comprises tapered sidewalls that depend downwardly and outwardly away from the outer periphery of the suction area. The tapered sidewalls and the outer periphery of the suction area are configured and dimensioned to cause an electronic device to substantially self-align and center itself with respect to the collet when engaged thereby.

### FIELD OF THE INVENTION

Various embodiments of the invention described herein relate to the field of pick and place machines, and more particularly to pick and place collets therefor.

### BACKGROUND

SMT (surface mount technology) component placement systems, commonly called pick and place machines, are robotic machines used to place surface-mount devices (SMDs), integrated circuits and other electronic devices onto, for example, printed circuit boards (PCBs) or tapes for subsequent packaging and distribution to customers. Pick and place machines are used for high speed, high precision placing of a broad range of electronic components, such as capacitors, resistors, integrated circuits onto PCBs or tapes, or in reel pockets, and the like. Such machines typically use pneumatic collets, which are may be accurately manipulated in three dimensions.

When transferring electronic devices at high rates of speed from one location to another using a vacuum-operated collet, alignment errors can occur. For example, if electronic devices provided in tubes are to be transferred from the tubes to pockets on a reel, misalignments can occur as the devices are transferred by the collet from the tubes to the pockets, which can result in damage to the misaligned electronic device, or to other devices packaged on the same reel.

Among other things, what is needed is a pick and place machine having a reduced rate of electronic devices picked and placed thereby that are misaligned.

### SUMMARY

In one embodiment, there is provided a self-aligning pick and place collet having proximal and distal ends configured for use with a tape and reel machine comprising a vacuum aperture disposed between the proximal and distal ends of the collet and configured to pull a vacuum through a distal portion thereof, a suction area located at the distal end of the collet, the suction area being contiguous with and adjoining the distal portion of the vacuum aperture and defining a first outer periphery, the suction area being substantially perpendicular to an imaginary axis of the vacuum aperture, and a pick and place collet contact area located adjacent to and outwardly from the suction area, the pick and place collet contact area comprising tapered sidewalls that depend downwardly and outwardly away from the first outer periphery of the suction area, wherein the distal end of the collet and the suction area are configured to permit the suction area to be placed over a top surface of an electronic device, and the tapered sidewalls and the first outer periphery of the suction area are configured and dimensioned to cause the electronic device to substantially self-align and center itself with respect to the collet after the distal end of the collet has been placed over the electronic device and portions of the tapered sidewalls have engaged a second outer periphery of the top surface of the electronic device, the collet being configured to permit the electronic device to be picked up after the vacuum has been applied through the vacuum aperture thereto.

In another embodiment, there is provided a tape and reel machine for picking and placing electronic devices comprising a self-aligning pick and place collet having proximal and distal ends configured for use with the tape and reel machine, a vacuum aperture disposed between the proximal and distal ends of the collet and configured to pull a vacuum through a distal portion thereof, a suction area located at the distal end of the collet, the suction area being contiguous with and adjoining the distal portion of the vacuum aperture and defining a first outer periphery, the suction area being substantially perpendicular to an imaginary axis of the vacuum aperture, and a pick and place collet contact area located adjacent to and outwardly from the suction area, the pick and place collet contact area comprising tapered sidewalls that depend downwardly and outwardly away from the first outer periphery of the suction area, wherein the distal end of the collet and the suction area are configured to permit the suction area to be placed over a top surface of one of the electronic devices, and the tapered sidewalls and the first outer periphery of the suction area are configured and dimensioned to cause the electronic device to substantially self-align and center itself with respect to the collet after the distal end of the collet has been placed over the electronic device and portions of the tapered sidewalls have engaged a second outer periphery of the top surface of the electronic device, the collet being configured to permit the electronic device to be picked up after the vacuum has been applied through the vacuum aperture thereto.

In yet another embodiment, there is provided a method of picking and placing electronic devices with a tape and reel machine comprising placing a self-aligning pick and place collet having proximal and distal ends over a selected one of the electronic devices disposed on a reel, causing the collet to move downwardly and engage portions of the selected electronic device such that tapered sidewalls of a pick and place collet contact area located adjacent to and outwardly from a suction area disposed at a distal end of the collet, where the tapered sidewalls depend downwardly and outwardly away from a first outer periphery of the suction area, cause the selected electronic device to substantially self-align and center itself with respect to the collet, and picking the selected electronic device up with the collet after a vacuum has been applied through a vacuum aperture located in the collet.

Further embodiments are disclosed herein or will become apparent to those skilled in the art after having read and understood the specification and drawings hereof.

### BRIEF DESCRIPTION OF THE DRAWINGS

Different aspects of the various embodiments will become apparent from the following specification, drawings and claims in which:

FIG. 1 shows a representative example of a prior art pick and place machine with associated tape and reel equipment;

FIG. 2 shows a portion of prior art pick and place machine 10 of FIG. 1;

FIG. 3 shows a cross-sectional view of prior art collet 20;

FIG. 4 shows a successful pick and placement of electronic device 42 into pocket 16 of reel 12;

FIG. 5 shows a misaligned pick and placement of electronic device 42 into pocket 16 of reel 12;

FIG. 6 shows one embodiment of collet 20 configured to overcome misalignment problems;

FIGS. 6, 7 and 8 and show various aspects of collet 20 according to one embodiment thereof;

FIG. 9 shows one embodiment of method 100 of operating a tape and reel machine, and

FIG. 10 shows one embodiment of method 200 corresponding to a pick and place procedure.

The drawings are not necessarily to scale. Like numbers refer to like parts or steps throughout the drawings.

### DETAILED DESCRIPTIONS OF SOME EMBODIMENTS

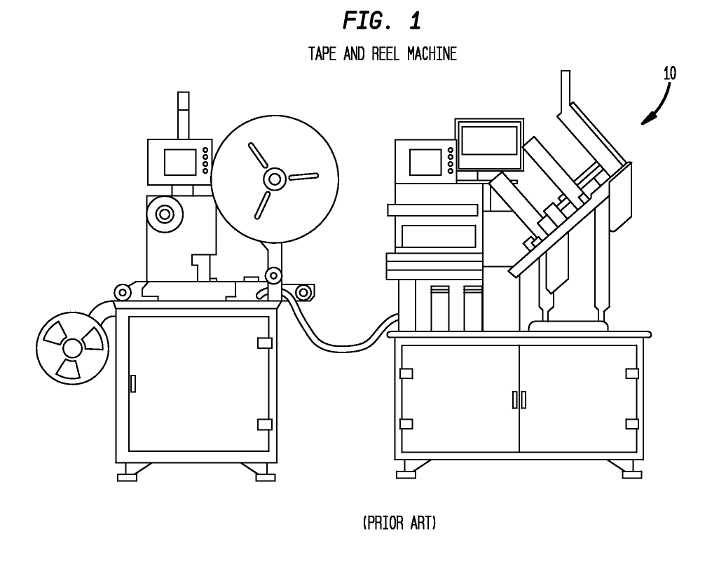

FIG. 1 shows a representative example of a prior art pick and place machine with associated tape and reel equipment.

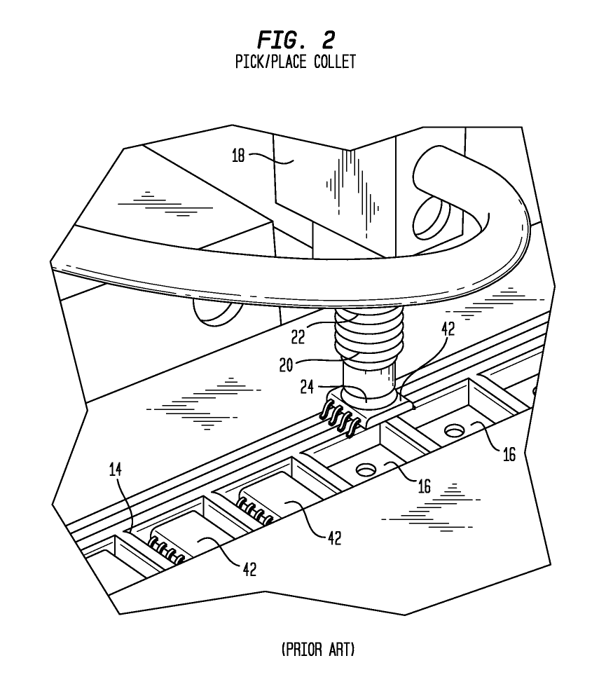

FIG. 2 shows a portion of prior art pick and place machine 10 of FIG. 1, where pick and place collet 20 having proximal end 22 and distal end 24 is configured to pick up electronic device 42 using suction delivered through a vacuum aperture 26 (not shown in FIG. 1, but shown in FIG. 2) to distal end 24 thereof. Device 42 is positioned by collet 20 over reel pocket 16, and then deposited therein by releasing the suction or vacuum that has been applied thereto by collet 20. The reel is moved to position the next empty pocket 16 at an appropriate location respecting the collet, and the process is repeated.

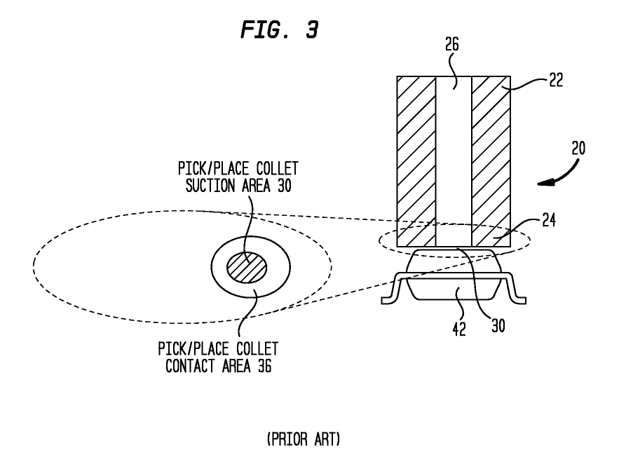

FIG. 3 shows a cross-sectional view of prior art collet 20 having proximal and distal ends 22 and 24, and vacuum aperture 26. Suction area 30 is placed over electronic device 42, a vacuum is applied through vacuum aperture 26, and electronic device 42 is brought into contact with suction area 30 such that device 42 can be picked up and placed by collet 20 in pocket 16 when the vacuum is released. In the semiconductor market, packaged SMT parts are often packed on tapes and reels that are prepared using collets 20 of the type shown in FIG. 3, where the collet has a blunt or flat distal end configured to engage a top surface of each picked and placed electronic device 42 when a vacuum is applied through the vacuum aperture of the collet.

Experience has shown that during high speed automated pick and place operations the configuration and design of collet 20 shown in FIG. 3 is susceptible to alignment problems respecting the accurate picking and placing of electronic devices 42 in pockets 16. For example, when electronic devices 42 are delivered in tubes and must be transferred at high speeds from the tubes to tapes and reels using pick and place machine 10, an additional alignment stage is sometimes required after the pick operation, but before the place operation if misalignment errors are to be avoided. Adding this extra step decreases the efficiency of the pick and place operation, sometimes markedly.

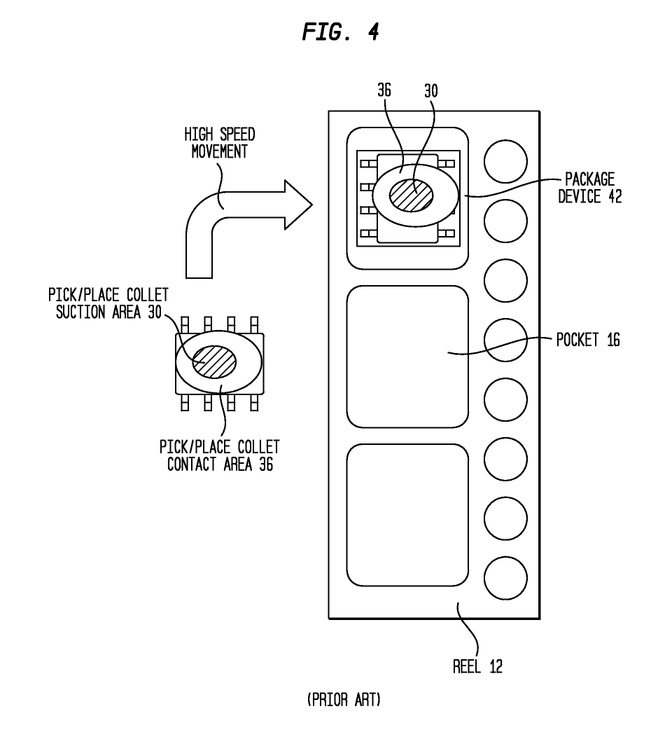

FIG. 4 shows a successful pick and placement of electronic device 42 into pocket 16 of reel 12, where device 42 is appropriately and accurately aligned with respect to the edges of pocket 16 when placed therein. During the pick action, a vacuum is created at distal end 24 of collet 20 and device 42 is picked up. Distal end 24 of collet 20 and suction area 30 create a surface suction on a top surface of device 42 that is sufficiently strong to prevent device 42 from rotating during transfer to pocket 16. During the place action in pocket 16, the vacuum in collet 20 is released and device 42 drops into pocket 16 of reel 12.

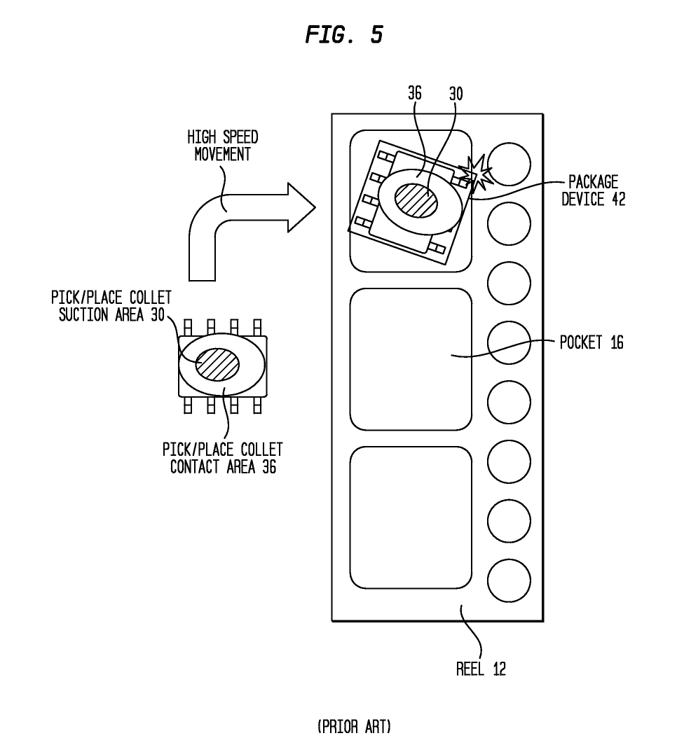

FIG. 5 shows a misaligned pick and placement of electronic device 42 into pocket 16 of reel 12, where device 42 is skewed with respect to the edges of pocket 16. During high speed movement of collet 20, devices 42 sometimes rotate and hit the edges of pocket 16 during the place action.

Misalignment of device 42 with respect to pocket 16 can cause cascading problems, such as damage to device 42, damage to other devices 42 on reel 12, and damage to reel 12. Misalignment of device 42 with respect to pocket 16 can also cause distorted or bent leads on device 42, or pick and place machine stoppages.

Several factors have been discovered to contribute to device misalignments during pick and place operations, including, but not limited to, the vacuum being pulled through vacuum aperture 26 not being strong enough, suction force dropping to unacceptably low levels due to the accumulation or presence of dirt and debris in or around suction area 30 of collet 20 or other portions of distal end 24 of collet 20, and portions of distal end 24 of collet 20 having been subjected to excessive wear, tear, use, contamination, degradation, and/or abrasion.

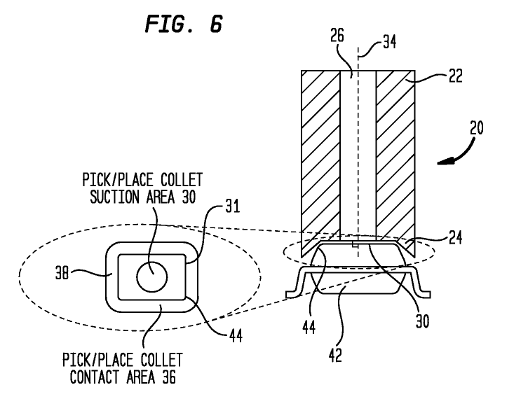

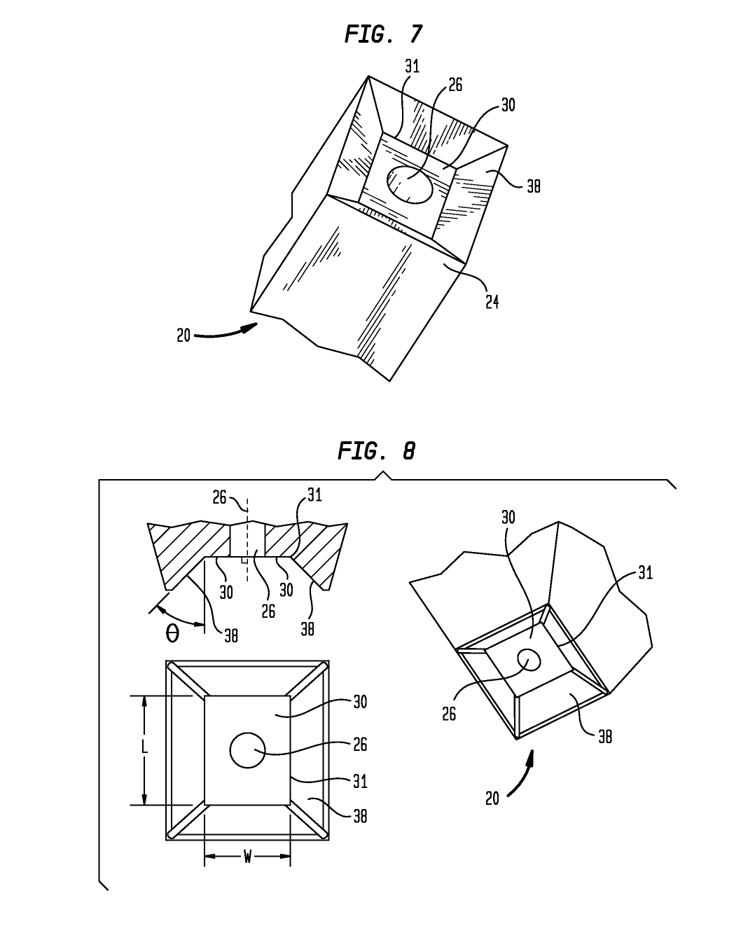

Referring now to FIG. 6, there is shown one embodiment of collet 20 that is configured to overcome at least some of the above-described misalignment problems that can occur during a pick and place operation. As shown in FIG. 6, self-aligning pick and place collet 20 has proximal and distal ends 22 and 24 configured for use with a tape and reel machine 10. Vacuum aperture 26 is disposed between proximal and distal ends 22 and 24 of collet 20, and is configured to pull a vacuum through a distal portion thereof. Suction area 30 is located at distal end 24 of collet 20, and is contiguous with and adjoins the distal portion of vacuum aperture 26 to define a first outer periphery 31. In one embodiment, suction area 30 is substantially perpendicular to imaginary axis 34 of vacuum aperture 26, although other orientations and configurations are contemplated.

Continuing to refer to FIG. 6, pick and place collet contact area 36 is located adjacent to and outwardly from suction area 31 and first outer periphery 31. As shown in FIG. 6, pick and place collet contact area 36 comprises tapered sidewalls 38 that depend downwardly and outwardly away from first outer periphery 31 of suction area 30. Distal end of collet 24 and suction area 30 are together configured to permit suction area 30 to be placed over a top surface of electronic device 42. Tapered sidewalls 38 and first outer periphery 31 of suction area 30 are configured and dimensioned to cause electronic device 42 to substantially self-align and center itself with respect to collet 20 after distal end 24 of collet 20 has been placed over electronic device 42 and portions of tapered sidewalls 38 have engaged second outer periphery 44 of the top surface of electronic device 42. Collet 20 is further configured to permit electronic device 42 to be picked up after the vacuum has been applied through vacuum aperture 26 thereto.

Referring now to FIGS. 6, 7 and 8, and according to one embodiment, suction area 30 is substantially flat, and tapered sidewalls 38 may be at least partially flexible or malleable to facilitate the development of good suction on the top and/or side surfaces of device 42. Moreover, tapered sidewalls 38 may be configured to prevent electronic device 42 from rotating with respect to distal end 24 of collet 20 after portions of tapered sidewalls 38 have engaged second outer periphery 44 of electronic device 42, and/or after the vacuum has been applied thereto

Tapered sidewalls 38, distal end 24 and suction area 30 may be configured, dimensioned, sized and shaped to permit electronic devices 42 of given dimensions and other physical characteristics such as friction or smoothness to be optimally picked up and self-aligned by collet 20. For example, sidewalls 38, distal end 24 and suction area 30 may be configured, dimensioned, sized and shaped to pick up Surface Mount Technology (SMT) parts, Surface Mount Device (SMD) parts, integrated circuits, and so on, depending on the particular requirements at hand.

According to various embodiments shown in FIGS. 6 through 8, it will be seen that device 42 does not rotate or otherwise become misaligned during the pick and place operation. Instead of the flat contact surface collet shown in FIGS. 2 through 5, tapered edge collet 20 of FIGS. 6 through 8 is configured to hold device 42 correctly aligned during the transfer operation to pocket 16. Even when debris or dirt accumulate in suction area 30, device 42 will generally not rotate during the transfer operation. Self-aligning collet 20 disclosed and described herein causes device 42 to self-align during the pick operation so that device 42 self-aligns into proper alignment and a correct position during the pick and place operation. During the transfer operation to pocket 16, device 42 does not rotate, as it is held firmly in position through the combined actions of tapered sidewalls 38 and the vacuum applied to the top surface of device 42. Collet 20 of FIGS. 6 through 8 also simplifies SMT processes.

As further shown in FIGS. 6, 7 and 8, first outer periphery 31 of suction area 30 may be substantially rectangular in shape, although other shapes and configurations are contemplated, such as first outer periphery 31 being at least partially curved in shape. Likewise, the portions of tapered sidewalls 38 that engage second outer periphery 44 of electronic device 42 may define a substantially rectangular shape, or may be otherwise configured and shaped according to the dimensions and shape of device 42 that is to be picked and placed.

Set forth below in Table 1, and with further reference to FIG. 8, are width (W) and length (L) dimensions and angular characteristics (θ) of distal end 24 of collet 20 according to one embodiment configured to pick and place 8-pin DIP packages having a certain predetermined shape and dimensions. It will now be appreciated by those skilled in the art that distal end 24 of collet is best configured, optimized and customized in respect of the shape and dimensions of the particular device 42 that is to be picked and placed by machine 10.

| | θ (degree) | L (inches) | W (inches) |
|---|---|---|---|
| 1 | 30 | 0.400 | 0.320 |
| 2 | 30 | 0.220 | 0.175 |
| 3 | 30 | 0.462 | 0.374 |

Corresponding to the teachings and disclosures made above are various methods of picking and placing electronic devices 42 with tape and reel machine 10. Such methods include steps comprising placing self-aligning pick and place collet 20 having proximal and distal ends 22 and 24 over a selected one of electronic devices 42 disposed on reel 12, causing collet 20 to move downwardly and engage portions of the selected electronic device 42 such that tapered sidewalls 38 of pick and place collet contact area 36 located adjacent to and outwardly from suction area 30 disposed at a distal end of collet 20, where tapered sidewalls 38 depend downwardly and outwardly away from first outer periphery 31 of suction area 30, cause selected electronic device 42 to substantially self-align and center itself with respect to collet 20. These steps are then followed by picking selected electronic device 42 up with collet 20 after a vacuum has been applied through vacuum aperture 26 located in collet 20, and may further include one or more of moving selected electronic device 42 over a tape 14 or reel 12, placing selected electronic device 42 in pocket 16, releasing the vacuum in collet 20 and moving collet 20 away from selected electronic device 42, and repeating the steps recited above with respect to another selected electronic device 42.

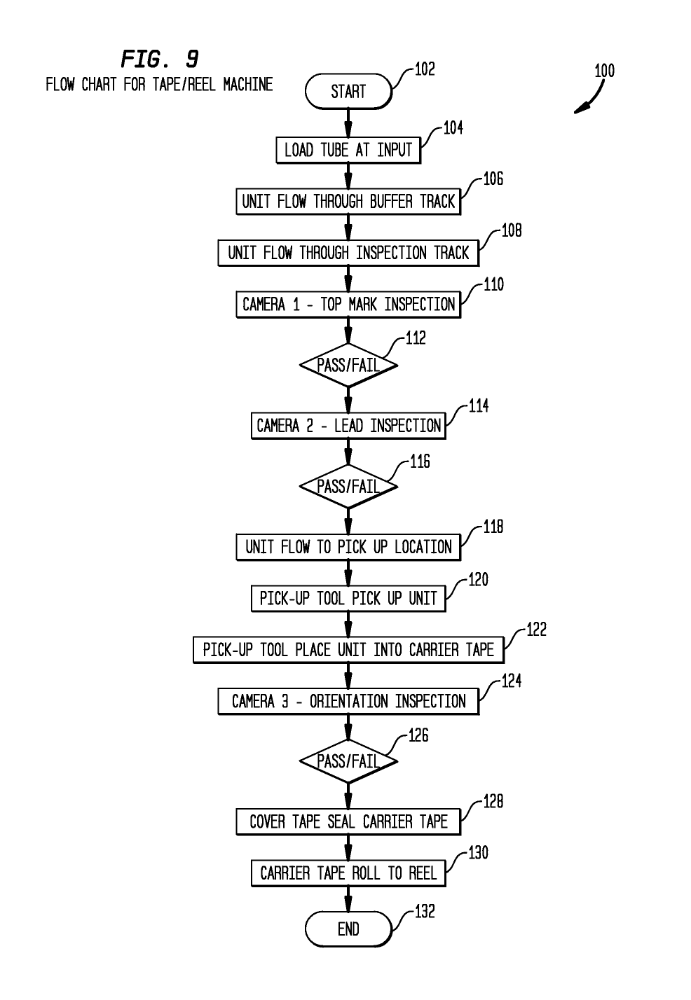

Referring now to FIG. 9, there is shown one embodiment of a method 100 of operating a tape and reel machine. Method 100 of FIG. 9 starts at step 102, followed by loading a tube containing devices 42 at step 104. Devices 42 flow through a buffer track at step 106 and an inspection track at step 108. Camera 1 is used to effect top mark inspection of devices 42 at step 110. A pass/fail step is included at step 112 to reject bad devices 42. Leads on devices 42 are inspected by camera 2 at step 114. At step 118, devices 42 flow to their respective pick-up locations, where the pick-up tool and collet 20 pick device 42 up at step 120, pick-up tool and collet 20 place devices 42 onto carrier tape 14 at step 122, and camera 3 inspects devices 42 for proper orientation and registration at step 124. Step 124 is followed by pass/fail step 126, placing a covering seal over carrier tape 14 at step 128, and placing the carrier tape roll onto reel 12 at step 130. Method 100 of FIG. 9 terminates at step 132.

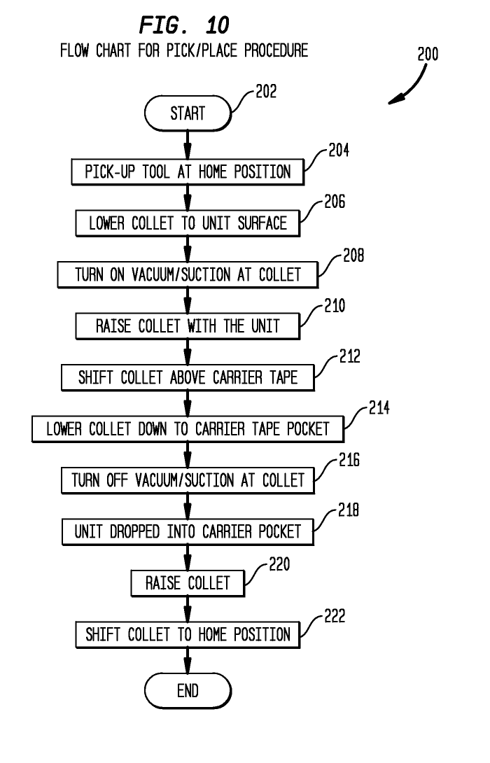

FIG. 10 shows one embodiment of a method 200 corresponding to a pick and place procedure. Method 200 of FIG. 10 starts at step 202, followed by placing pick-up tool and collet 20 in a home position. Collet 20 is lowered into position over selected device 42 at step 206, where a vacuum is applied to collet 20. Collet 20 is raised at step 210 with device 42 held thereto. Collet 20 is shifted into position above carrier tape 14 at step 212, followed by lowering collet 20 over pocket 16 on carrier tape 214. The vacuum applied to collet 20 is then turned off at step 216, and device 42 is dropped into pocket 16 at step 218. Collet 20 is raised from carrier tape pocket 16 at step 220, shifted to the home position at step 222, and method 200 is repeated for the next device 42 to be loaded onto carrier tape 14. Method 200 of FIG. 10 terminates at step 224 once all devices 42 have been loaded onto carrier tape 14.

The steps described above and illustrated in FIGS. 9 and 10 with respect to methods 100 and 200 may be changed and modified according to the particular requirements at hand. Other embodiments of methods 100 and 200 are contemplated.

The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations and modifications of the foregoing embodiments of the present invention not set forth explicitly herein will nevertheless fall within the scope of the present invention.

We claim:

1. A self-aligning pick and place collet having proximal and distal ends configured for use with a tape and reel machine, comprising:
a vacuum aperture disposed between the proximal and distal ends of the collet and configured to pull a vacuum through a distal portion thereof;
a suction area located at the distal end of the collet, the suction area being contiguous with and adjoining the distal portion of the vacuum aperture and defining a first outer periphery, the suction area being substantially perpendicular to an imaginary axis of the vacuum aperture, and
a pick and place collet contact area located adjacent to and outwardly from the suction area, the pick and place collet contact area comprising tapered sidewalls that depend downwardly and outwardly away from the first outer periphery of the suction area;
wherein the distal end of the collet and the suction area are configured to permit the suction area to be placed over a top surface of an electronic device, and the tapered sidewalls and the first outer periphery of the suction area are configured and dimensioned to cause the electronic device to substantially self-align and center itself with respect to the collet after the distal end of the collet has been placed over the electronic device and portions of the tapered sidewalls have engaged a second outer periphery of the top surface of the electronic device, the collet being configured to permit the electronic device to be picked up after the vacuum has been applied through the vacuum aperture thereto.

2. The self-aligning pick and place collet of claim 1, wherein the suction area is substantially flat.

3. The self-aligning pick and place collet of claim 1, wherein the tapered sidewalls are at least partially flexible or malleable.

4. The self-aligning pick and place collet of claim 1, wherein the tapered sidewalls are further configured to prevent the electronic device from rotating with respect to the distal end of the collet after portions of the tapered sidewalls have engaged the second outer periphery of the electronic device.

5. The self-aligning pick and place collet of claim 1, wherein the tapered sidewalls are further configured to prevent the electronic device from rotating with respect to the distal end of the collet after portions of the tapered sidewalls have engaged the second outer periphery of the electronic device and the vacuum has been applied thereto.

6. The self-aligning pick and place collet of claim 1, wherein the tapered sidewalls and the outer periphery of the suction area are configured and dimensioned to permit the electronic device to substantially self-align and center itself with respect to the collet after the distal end of the collet has been placed over the electronic device and portions of the tapered sidewalls have engaged the second outer periphery of the top surface of the electronic device when the electronic device is a Surface Mount Technology (SMT) part.

7. The self-aligning pick and place collet of claim 1, wherein the tapered sidewalls and the outer periphery of the suction area are configured and dimensioned to permit the electronic device to substantially self-align and center itself with respect to the collet after the distal end of the collet has been placed over the electronic device and portions of the tapered sidewalls have engaged the second outer periphery of the top surface of the electronic device when the electronic device is a Surface Mount Device (SMD) part.

8. The self-aligning pick and place collet of claim 1, wherein the first outer periphery of the suction area is substantially rectangular in shape.

9. The self-aligning pick and place collet of claim 1, wherein the first outer periphery of the suction area is at least partially curved in shape.

10. The self-aligning pick and place collet of claim 1, wherein the portions of the tapered sidewalls that engage the second outer periphery of the electronic device define a substantially rectangular shape.

11. A tape and reel machine for picking and placing electronic devices, comprising:
a self-aligning pick and place collet having proximal and distal ends configured for use with the tape and reel machine;
a vacuum aperture disposed between the proximal and distal ends of the collet and configured to pull a vacuum through a distal portion thereof;
a suction area located at the distal end of the collet, the suction area being contiguous with and adjoining the distal portion of the vacuum aperture and defining a first outer periphery, the suction area being substantially perpendicular to an imaginary axis of the vacuum aperture, and
a pick and place collet contact area located adjacent to and outwardly from the suction area, the pick and place collet contact area comprising tapered sidewalls that depend downwardly and outwardly away from the first outer periphery of the suction area;
wherein the distal end of the collet and the suction area are configured to permit the suction area to be placed over a top surface of one of the electronic devices, and the tapered sidewalls and the first outer periphery of the suction area are configured and dimensioned to cause the electronic device to substantially self-align and center itself with respect to the collet after the distal end of the collet has been placed over the electronic device and portions of the tapered sidewalls have engaged a second outer periphery of the top surface of the electronic device, the collet being configured to permit the electronic device to be picked up after the vacuum has been applied through the vacuum aperture thereto.

12. The tape and reel machine of claim 11, wherein the suction area is substantially flat.

13. The tape and reel machine of claim 11, wherein the tapered sidewalls are at least partially flexible or malleable.

14. The tape and reel machine of claim 11, wherein the tapered sidewalls are further configured to prevent the electronic device from rotating with respect to the distal end of the collet after portions of the tapered sidewalls have engaged the second outer periphery of the electronic device.

15. The tape and reel machine of claim 11, wherein the tapered sidewalls are further configured to prevent the electronic device from rotating with respect to the distal end of the collet after portions of the tapered sidewalls have engaged the second outer periphery of the electronic device and the vacuum has been applied thereto.

16. The tape and reel machine of claim 11, wherein the tapered sidewalls and the outer periphery of the suction area are configured and dimensioned to permit the electronic device to substantially self-align and center itself with respect to the collet after the distal end of the collet has been placed over the electronic device and portions of the tapered sidewalls have engaged the second outer periphery of the top surface of the electronic device when the electronic device is a Surface Mount Technology (SMT) part.

17. The tape and reel machine of claim 11, wherein the tapered sidewalls and the outer periphery of the suction area are configured and dimensioned to permit the electronic device to substantially self-align and center itself with respect to the collet after the distal end of the collet has been placed over the electronic device and portions of the tapered sidewalls have engaged the second outer periphery of the top surface of the electronic device when the electronic device is a Surface Mount Device (SMD) part.

18. The tape and reel machine of claim 11, wherein the first outer periphery of the suction area is substantially rectangular in shape.

19. The tape and reel machine of claim 11, wherein the first outer periphery of the suction area is at least partially curved in shape.

20. The tape and reel machine of claim 11, wherein the portions of the tapered sidewalls that engage the second outer periphery of the electronic device define a substantially rectangular shape.

21. A method of picking and placing electronic devices with a tape and reel machine, comprising:
placing a self-aligning pick and place collet having proximal and distal ends over a selected one of the electronic devices disposed on a reel;
causing the collet to move downwardly and engage portions of the selected electronic device such that tapered sidewalls of a pick and place collet contact area located adjacent to and outwardly from a suction area disposed at a distal end of the collet, where the tapered sidewalls depend downwardly and outwardly away from a first outer periphery of the suction area, cause the selected electronic device to substantially self-align and center itself with respect to the collet, and picking the selected electronic device up with the collet after a vacuum has been applied through a vacuum aperture located in the collet.

22. The method of claim 21, further comprising moving the selected electronic device over a tape.

23. The method of claim 22, further comprising placing the selected electronic device in a pocket disposed over the tape.

24. The method of claim 23, further comprising releasing the vacuum in the collet and moving the collet away from the selected electronic device.

25. The method of claims 21 through 24, further comprising repeating the steps recited therein with respect to another selected electronic device.
